(19) United States
(12) Patent Application Publication
(10) Pub. No.: US 2010/0015317 A1
(43) Pub. Date: Jan. 21, 2010

(54) COMPOSITIONS AND RECIPES FOR GLUTEN-FREE BAKED PRODUCTS

(76) Inventor: Dawna DeStafeno, Folsom, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/569,742

(22) Filed: Sep. 29, 2009

Related U.S. Application Data
(62) Division of application No. 11/972,604, filed on Jan. 10, 2008.

(51) Int. Cl. A21D 10/00

(52) U.S. Cl. 426/550

(57) ABSTRACT

Gluten-free vegan mixtures, compositions and recipes for baked goods with improved qualities including, but not limited to, taste, texture consistency and nutritional value. In one embodiment, a recipe for preparing a dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda and 1/58 part any combination of guar, xanthium, locust bean gums and/or locust root.

### RELATED APPLICATION

This application is a divisional of U.S. patent application Ser. No. 11/972,604, filed Jan. 10, 2008, the contents of which are incorporated by reference herein in its entirety.

### BACKGROUND

1. Field

The present invention generally pertains to gluten-free, egg-free, dairy free (vegan) dry and wet mixtures used in cooking and more particularly, to compositions gluten-free, egg-free, dairy free (vegan) mixtures and composition used in baked goods to provide baked goods with exceptional taste, texture and nutritional content.

The growing numbers of people with celiac disease, wheat intolerance, lactose intolerance, food allergies, autism, diabetes, and vegan or vegetarian life style choices have grown. Celiac disease is common: affecting an average of 1 in 133 Americans and up to 1 in 7 for those associated with risk factors. Celiac disease is often misdiagnosed as Irritable Bowel Syndrome (IBS) or lactose intolerance and up to ⅓ of Celiac Disease patients have been previously diagnosed with IBS. With the emergence of a popular food consciousness in recent years has come something of a diner consciousness: can Billy eat that cupcake? Increasingly, he can't. Hysteria aside, this much is true: the number of food-allergy sufferers in America has risen from 7 million to 12 million over the last five years, according to the nonprofit Food Allergy Initiative. Researchers at the Mount Sinai School of Medicine found that in 1997 1 in 250 preschoolers suffered from peanut allergy—the most dangerous variety; five years later, that number has jumped to 1 in 125. Accordingly, food allergies and safety is a growing concern affecting more and more Americans every day.

Symptoms of celiac disease may include one or more of the following: recurring abdominal bloating and pain, chronic diarrhea, weight loss, pale, foul-smelling stool, unexplained anemia (low count of red blood cells), gas, bone pain, behavior changes, muscle cramps, fatigue, delayed growth, failure to thrive in infants, pain in the joints, seizures, tingling numbness in the legs (from nerve damage), pale sores inside the mouth, called aphthus ulcers, painful skin rash, called dermatitis herpetiformis, tooth discoloration or loss of enamel, missed menstrual periods (often because of excessive weight loss). Anemia, delayed growth, and weight loss are signs of malnutrition—not getting enough nutrients. Malnutrition is a serious problem for anyone, but particularly for children because adequate nutrition is necessary for proper development in a growing child.

Egg Allergy Information

When a person is allergic to eggs, one of the things that occur is the body's immune system overreacts to proteins in the egg. Every time something made with eggs enters the digestive system of a person with an egg allergy, the body thinks that these proteins are harmful invaders. So when a person with an egg allergy eats a food that contains eggs, the immune system unleashes an immune response to protect the body. The release of these chemicals can affect the respiratory system, gastrointestinal tract, skin, and the cardiovascular system—causing allergy symptoms like wheezing, nausea, headache, stomachache, and itchy hives.

Gluten based traditional baked goods always contain wheat-based flour combinations, (whole-wheat flour, malted barley flour, rye flour, etc.) and are held together with eggs and dairy products. These products can be mass-produced inexpensively and are readily available. But people with celiac or food allergies often have negative reaction to products containing gluten.

Gluten-free baked goods always contain non-gluten containing flour, like rice and/or tapioca; these recipes also almost always contain eggs, and milk products to create a product that usually ends up lacking in flavor and texture. Accordingly, there exists a need for agreeable and even delicious foods that do not contain wheat, gluten, rye, oats, barley, spelt, tritical, or egg dairy, butter, hydrogenated oils, processed sugars, or other ingredients to which many people are allergic and affect those with celiac disease.

Subsequently, gluten-free vegan dry and wet mixture recipes and compositions, which can be used in all foods, are needed, especially for baked goods, to create wholesome food with superior taste, texture, and high nutritional content. The present invention provides these and other related advantages.

### SUMMARY

Methods and related compositions are provided for providing dry and wet mixtures and compositions for all foods, including baked products, which result in gluten-free vegan foods having improved taste, texture, consistency and nutritional value.

In one embodiment of the present invention, a recipe for preparing a dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda and 1/58 part any combination of guar, xanthium, locust bean gums and/or locust root.

In an aspect of at least one embodiment of the present invention, approximately 3/7 part margarine is added to the dry mix to make a scone dry mix.

In another aspect of the present invention, approximately 3/14 part sugar is added to the dry mix to make a scone dry mix.

In yet another aspect of at least one embodiment of the present invention, approximately 1/11 part pecan and/or flax meal is added to the dry mix to make a scone dry mix.

In another embodiment of the present invention, a recipe for preparing chocolate dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda, 1/58 part any combination of guar, xanthium, locust bean gums and/or locust root and 1/9 part cocoa powder.

In yet another embodiment of the present invention, a recipe for preparing chocolate dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda, 1/58 part any combination of guar, xanthium, locust bean gums and/or locust root and 1/11 part dark cocoa powder.

In yet another embodiment of the present invention, a recipe for preparing a dry mix for gluten-free white bread is provided. The recipe is comprised of approximately 31/100 part rice flour, approximately 16/100 part bean flour, approximately 7.5/100 part tapioca starch, approximately 7.5/100 part corn starch, approximately 3/500 part baking powder, approximately 4/1000 part baking soda, approximately 1/58 part any combination of guar, xanthium, locust bean gums and/or locust root, approximately 36/100 part tapioca flour, approximately 1/100 part potato flour and/or potato starch and approximately 4/100 part olive oil.

In yet another embodiment of the present invention, a recipe for preparing a dry mix for gluten-free dark bread is provided. The recipe is comprised of approximately 29/100 part rice flour, approximately 15/100 part bean flour, approximately 7/100 part tapioca starch, approximately 7/100 part corn starch, approximately 3/500 part baking powder, approximately 1/250 part baking soda, approximately 1/58 part any combination of guar, xanthium, locust bean gums and locust root, approximately 7/250 part flaxmeal, approximately 7/125 part stabilized rice bran, approximately 1/10 part sorghum flour, approximately 23/1000 part hemp seeds, approximately 3/250 part buckwheat groats, approximately 9/1000 part yeast, approximately 12/100 part sucanot, approximately 7/500 part sugar, approximately 7/500 part agave nectar.

In another aspect of at least one embodiment of the present invention, approximately 17/1000 part noni fruit is added to the dark bread dry mix recipe above.

In yet another embodiment of the present invention, a recipe for preparing a dry mix for gluten-free light bread is provided. The recipe is comprised of approximately 31/100 part rice flour, approximately 31/200 part bean flour, approximately 3/40 part tapioca starch, approximately 3/40 part corn starch, approximately 3/500 part baking powder, approximately 1/250 part baking soda, approximately 1/58 part any combination of guar, xanthium, locust bean gums and locust root, approximately 3/100 part flaxmeal, approximately 5/100 part brown rice powder, approximately 21/200 part sorghum flour, approximately 1/40 part hemp seeds, approximately 6/500 part buckwheat groats, approximately 9/1000 part yeast, approximately 3/40 part flaxseed, approximately 3/200 part sugar and approximately 37/1000 part palm shortening.

In yet another embodiment of the present invention, a recipe for preparing a wet mix for gluten-free baked goods is provided. The recipe is comprised of approximately 62/100 part soy, hemp, potato and/or almond milk, approximately 31/100 part rice milk or water, approximately 33/500 part oil, and approximately 1/100 part soy lecithin.

In yet another embodiment of the present invention, a recipe for preparing a dry base mixture for gluten-free baked goods is provided. The recipe is comprised of a mixture of any non-gluten containing flour from one or more rice or bean family (e.g., white rice, brown rice, pinto bean, navy bean, fava bean, garbonzo bean, black bean, kidney bean, black and/or white eyed peas, and/or lentil) and modified starch (e.g., tapioca, potato and/or Expandex) combined with cornstarch in approximately equal proportions to form a base dry mixture.

In another aspect of at least one embodiment of the present invention, one or more of guar and/or xanthan (locust bean) gum, baking soda, salt and baking powder is added to the base dry mixture to improve taste and consistency.

In another aspect of at least one embodiment of the present invention, a composition of one or more of soy, rice, hemp and/or almond milk, oil and soy lecithin is added to the dry base mixtures disclosed herein.

In another embodiment of the present invention, a composition or mixture of guar gum, xanathan gum, non-gluten flour, oil, soy lecithin, vanilla extracts, soda, salt and baking powder is provided.

In yet another embodiment of the present invention, a base dry mix is provided. The base dry mix is comprised of the following ingredients: approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda.

In yet another embodiment of the present invention, a chocolate dry base mix is provided. The chocolate dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda, combined with approximately ¾ cup dark cocoa and 1½ cup cocoa.

In yet another aspect of at least one embodiment of the present invention, the dark cocoa and cocoa of the chocolate dry mix is organic.

In yet another embodiment of the present invention, a scone dry base mix is provided. The scone dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda, combined with approximately 4 cups margarine, ½ cup pecan meal and/or flaxmeal and 1¾ cup sugar.

In yet another embodiment of the present invention, a scone dry base mix is provided. The scone dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda, combined with approximately 4 cups vegan butter or margarine-like spread (e.g., Earth Balance® vegan buttery spread), ½ cup organic pecan meal and/or flaxmeal, 1¾ cup organic evaporated cane juice and 1¾ cup organic maple sugar.

In yet another embodiment of the present invention, a dry base mix is provided. The dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda combined with approximately 1 cup stabilized rice bran, ½ cup flaxmeal, ½ cup sorghum flour, ½ cup sucanot, ⅛ cup hemp seeds, 3½ tablespoons palm shortening, ⅓ cup yeast, 1 tablespoon buckwheat groats, 1 tablespoon agave nectar, 1 tablespoon sugar, 1 tablespoon dried or liquid noni fruit and 1 tablespoon apple cider vinegar.

In yet another aspect of at least one embodiment of the present invention, where applicable, organic ingredients are used and evaporated cane juice is used instead of sugar.

In yet another embodiment of the present invention, a dry base mix is provided. The dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda combined with approximately 1 cup brown rice flour and 1 cup roasted salted golden flaxseeds.

In yet another embodiment of the present invention, a crust (e.g., pizza crust) dry base mix is provided. The crust dry base mix is comprised of 1½ cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda combined with approximately ½ cup tapioca flour, ½ cup potato flour, ¼ cup buckwheat flour, ¼ cup potato starch and 3 tablespoons of olive oil.

In yet another embodiment of the present invention, a base dry mix is provided. The base dry mix is comprised of approximately the following ingredients: 2 cups organic rice flour, 1 cup organic bean flour, ½ cup organic tapioca starch, ½ cup organic cornstarch, 3½ teaspoons xanathan gum, 2½ teaspoons guar gum, ¼ teaspoon salt, ½ teaspoon aluminum free baking powder and ¼ teaspoon baking soda.

In yet another embodiment of the present invention, a wet base mix is provided. The wet base mix is comprised of approximately 8 cups soy milk, 4 cups rice, hemp or almond milk, 4 cups water, 3 tablespoons soy lecithin, 3 tablespoons vanilla extract, 3 tablespoons maple extract, 2 tablespoons soy lecithin, 1 cup canola, vegetable, olive and/or grape seed oil.

In yet another embodiment of the present invention, a wet base mix is provided. The wet base mix is comprised of approximately 8 cups organic soy milk, 4 cups organic vanilla rice, hemp or almond milk, 4 cups water, 1 cup raw whole almonds, 3 tablespoons soy lecithin, 6 tablespoons vanilla extract, 3 tablespoons soy lecithin, 1 cup canola, vegetable, extra virgin olive and/or grape seed oil.

It should be appreciated that it is within the scope of the present invention to scale any of the proportions and/or amounts of the ingredients or recipes disclosed herein to produce the desired amount of baked goods.

### DETAILED DESCRIPTION

A gluten-free baked good produced in accordance with the compositions, mixtures and recipes described and claimed herein provide better-tasting baked goods with a lighter and fluffier texture. When baked, the recipes, compositions and mixtures of the present invention result in gluten-free baked goods that will not only develop the desired consistency and appearance of a regular gluten or animal-product-containing baked goods, but the resulting baked good will have improved taste, texture and nutritional values when compared to all baked goods, gluten-free or otherwise.

In one embodiment of the present invention, a recipe for preparing a dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda and 1/58 part any combination of guar, xanthium, locust bean gums and/or locust root.

In an aspect of at least one embodiment of the present invention, approximately 3/7 part margarine is added to the dry mix to make a scone dry mix.

In another aspect of the present invention, approximately 3/14 part sugar is added to the dry mix to make a scone dry mix.

In yet another aspect of at least one embodiment of the present invention, approximately 1/11 part pecan and/or flax meal is added to the dry mix to make a scone dry mix.

In another embodiment of the present invention, a recipe for preparing chocolate dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda, 1/58 part any combination of guar, xanthium, locust bean gums and/or locust root and 1/9 part cocoa powder.

In yet another embodiment of the present invention, a recipe for preparing chocolate dry mix for gluten-free baked goods is provided. The recipe is comprised of approximately ½ part rice flour, ¼ part bean flour, ⅛ part tapioca starch, ⅛ part corn starch, 1/100 part baking powder, 3/500 part baking soda, 1/58 part any combination of guar, xanthium, locust bean gums and/or locust root and 1/11 part dark cocoa powder.

In yet another embodiment of the present invention, a recipe for preparing a dry mix for gluten-free white bread is provided. The recipe is comprised of approximately 31/100 part rice flour, approximately 16/100 part bean flour, approximately 7.5/100 part tapioca starch, approximately 7.5/100 part corn starch, approximately 3/500 part baking powder, approximately 4/1000 part baking soda, approximately 1/58 part any combination of guar, xanthium, locust bean gums and/or locust root, approximately 36/100 part tapioca flour, approximately 1/100 part potato flour and/or potato starch and approximately 4/100 part olive oil.

In yet another embodiment of the present invention, a recipe for preparing a dry mix for gluten-free dark bread is provided. The recipe is comprised of approximately 29/100 part rice flour, approximately 15/100 part bean flour, approximately 7/100 part tapioca starch, approximately 7/100 part corn starch, approximately 3/500 part baking powder, approximately 1/250 part baking soda, approximately 1/58 part any combination of guar, xanthium, locust bean gums and locust root, approximately 7/250 part flaxmeal, approximately 7/125 part stabilized rice bran, approximately 1/10 part sorghum flour, approximately 23/1000 part hemp seeds, approximately 3/250 part buckwheat groats, approximately 9/1000 part yeast, approximately 12/100 part sucanot, approximately 7/500 part sugar, approximately 7/500 part agave nectar.

In another aspect of at least one embodiment of the present invention, approximately 17/1000 part noni fruit is added to the dark bread dry mix recipe above.

In yet another embodiment of the present invention, a recipe for preparing a dry mix for gluten-free light bread is provided. The recipe is comprised of approximately 31/100 part rice flour, approximately 31/200 part bean flour, approximately 3/40 part tapioca starch, approximately 3/40 part corn starch, approximately 3/500 part baking powder, approximately 1/250 part baking soda, approximately 1/58 part any combination of guar, xanthium, locust bean gums and locust root, approximately 3/100 part flaxmeal, approximately 5/100 part brown rice powder, approximately 21/200 part sorghum flour, approximately 1/40 part hemp seeds, approximately 6/500 part buckwheat groats, approximately 9/1000 part yeast, approximately 3/40 part flaxseed, approximately 3/200 part sugar and approximately 37/1000 part palm shortening.

In yet another embodiment of the present invention, a recipe for preparing a wet mix for gluten-free baked goods is provided. The recipe is comprised of approximately 62/100 part soy, hemp, potato and/or almond milk, approximately 31/100 part rice milk or water, approximately 33/500 part oil, and approximately 1/100 part soy lecithin.

In yet another embodiment of the present invention, a recipe for preparing a dry base mixture for gluten-free baked goods is provided. The recipe is comprised of a mixture of any non-gluten containing flour from one or more rice or bean family (e.g., white rice, brown rice, pinto bean, navy bean, fava bean, garbonzo bean, black bean, kidney bean, black and/or white eyed peas, and/or lentil) and modified starch (e.g., tapioca, potato and/or Expandex) combined with cornstarch in approximately equal proportions to form a base dry mixture.

In another aspect of at least one embodiment of the present invention, one or more of guar and/or xanthan (locust bean) gum, baking soda, salt and baking powder is added to the base dry mixture to improve taste and consistency.

In another aspect of at least one embodiment of the present invention, a composition of one or more of soy, rice, hemp and/or almond milk, oil and soy lecithin is added to the dry base mixtures disclosed herein.

In another embodiment of the present invention, a composition or mixture of guar gum, xanathan gum, non-gluten flour, oil, soy lecithin, vanilla extracts, soda, salt and baking powder is provided.

In yet another embodiment of the present invention, a base dry mix is provided. The base dry mix is comprised of the following ingredients: approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda.

In yet another embodiment of the present invention, a chocolate dry base mix is provided. The chocolate dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda, combined with approximately ¾ cup dark cocoa and 1½ cup cocoa.

In yet another aspect of at least one embodiment of the present invention, the dark cocoa and cocoa of the chocolate dry mix is organic.

In yet another embodiment of the present invention, a scone dry base mix is provided. The scone dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda, combined with approximately 4 cups margarine, ½ cup pecan meal and/or flaxmeal and 1¾ cup sugar.

In yet another embodiment of the present invention, a scone dry base mix is provided. The scone dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda, combined with approximately 4 cups vegan butter or margarine-like spread (e.g., Earth Balance® vegan buttery spread), ½ cup organic pecan meal and/or flaxmeal, 1¾ cup organic evaporated cane juice and 1¾ cup organic maple sugar.

In yet another embodiment of the present invention, a dry base mix is provided. The dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda combined with approximately 1 cup stabilized rice bran, ½ cup flaxmeal, ½ cup sorghum flour, ½ cup sucanot, ⅛ cup hemp seeds, 3½ tablespoons palm shortening, ⅓ cup yeast, 1 tablespoon buckwheat groats, 1 tablespoon agave nectar, 1 tablespoon sugar, 1 tablespoon dried or liquid noni fruit and 1 tablespoon apple cider vinegar.

In yet another aspect of at least one embodiment of the present invention, where applicable, organic ingredients are used and evaporated cane juice is used instead of sugar.

In yet another embodiment of the present invention, a dry base mix is provided. The dry base mix is comprised of 4 cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda combined with approximately 1 cup brown rice flour and 1 cup roasted salted golden flaxseeds.

In yet another embodiment of the present invention, a crust (e.g., pizza crust) dry base mix is provided. The crust dry base mix is comprised of 1½ cups from the composition of approximately 2 cups rice flour, 1 cup bean flour, ½ cup tapioca starch, ½ cup cornstarch, 3½ teaspoons xanathan gum, 2½ teaspoons guar gum, ¼ teaspoon salt, ½ teaspoon baking powder and ¼ teaspoon baking soda combined with approximately ½ cup tapioca flour, ½ cup potato flour, ¼ cup buckwheat flour, ¼ cup potato starch and 3 tablespoons of olive oil.

In yet another embodiment of the present invention, a base dry mix is provided. The base dry mix is comprised of approximately the following ingredients: 2 cups organic rice flour, 1 cup organic bean flour, ½ cup organic tapioca starch, ½ cup organic cornstarch, 3½ teaspoons xanathan gum, 2½ teaspoons guar gum, ¼ teaspoon salt, ½ teaspoon aluminum free baking powder and ¼ teaspoon baking soda.

In yet another embodiment of the present invention, a wet base mix is provided. The wet base mix is comprised of approximately 8 cups soy milk, 4 cups rice, hemp or almond milk, 4 cups water, 3 tablespoons soy lecithin, 3 tablespoons vanilla extract, 3 tablespoons maple extract, 2 tablespoons soy lecithin, 1 cup canola, vegetable, olive and/or grape seed oil.

In yet another embodiment of the present invention, a wet base mix is provided. The wet base mix is comprised of approximately 8 cups organic soy milk, 4 cups organic vanilla rice, hemp or almond milk, 4 cups water, 1 cup raw whole almonds, 3 tablespoons soy lecithin, 6 tablespoons vanilla extract, 3 tablespoons soy lecithin, 1 cup canola, vegetable, extra virgin olive and/or grape seed oil.

In yet another embodiment of the present invention, a dry mix is provided in accordance with the ingredients and approximate amounts listed in Table 1 below.

TABLE 1

| Ingredient | Approximate Amount | |
|---|---|---|
| Rice flour | 2 | cups |
| Bean Flour | 1 | cup |
| Tapioca Starch | ½ | cup |
| Cornstarch | ½ | cup |
| Xanathan Gum | 3½ | teaspoon (t) |
| Guar Gum | 2½ | t |
| Salt | ¼ | t |
| Baking Powder | ½ | t |
| Baking Soda | ¼ | t |

In yet another embodiment of the present invention, a dry chocolate mix is provided in accordance with the ingredients and approximate amounts listed in Table 2 below.

TABLE 2

| Ingredient | Approximate Amount | |
|---|---|---|
| Dry Base From Table 1 | 4 | cups |
| Dark Cocoa | ¾ | cup |
| Cocoa | 1½ | cup |

In yet another embodiment of the present invention, a scone dry mix is provided in accordance with the ingredients and approximate amounts listed in Table 3 below.

TABLE 3

| Ingredient | Approximate Amount | |
|---|---|---|
| Dry Base From Table 1 | 4 | cups |
| Margarine | 4 | cups |
| Pecan Meal and/or Flaxmeal | ½ | cup |
| Sugar | 1¾ | cup |

In yet another embodiment of the present invention, a dry mix is provided in accordance with the ingredients and approximate amounts listed in Table 4 below.

TABLE 4

| Ingredient | Approximate Amount | |
|---|---|---|
| Dry Base From Table 1 | 4 | cups |
| Stabilized Rice Bran | 1 | cup |
| Flaxmeal | ½ | cup |
| Sorghum Flour | ½ | cup |
| Sucanot | ½ | cup |
| Hemp Seeds | ⅛ | cup |
| Palm Shortening | 3½ | teaspoons |
| Yeast | ⅓ | cup |
| Buckwheat Groats | 1 | tablespoon (Tbs) |
| Agave Nectar | 1 | Tbs |
| Sugar | 1 | Tbs |
| Pure Noni Fruit (dried or liquid) | 1 | Tbs |
| Apple Cider Vinegar | 1 | Tbs |

In yet another embodiment of the present invention, a dry mix is provided in accordance with the ingredients and approximate amounts listed in Table 5 below.

TABLE 5

| Ingredient | Approximate Amount | |
|---|---|---|
| Dry Base From Table 1 | 4 | cups |
| Brown Rice Flour | 1 | cup |
| Roasted Salted Golden Flaxseeds | 1 | cup |

In yet another embodiment of the present invention, a dry crust mix is provided in accordance with the ingredients and approximate amounts listed in Table 6 below.

TABLE 6

| Ingredient | Approximate Amount | |
|---|---|---|
| Dry Base From Table 1 | 1½ | cups |
| Tapioca Flour | ½ | cup |
| Potato Flour | ½ | cup |
| Buckwheat Flour | ¼ | cup |
| Potato Starch | ¼ | cup |
| Olive Oil | 3 | Tbs |

In yet another embodiment of the present invention, another dry base mix is provided in accordance with the ingredients and approximate amounts listed in Table 7 below.

TABLE 7

| Ingredient | Approximate Amount | |
|---|---|---|
| Organic Rice flour | 2 | cups |
| Organic Bean Flour | 1 | cup |
| Organic Tapioca Starch | ½ | cup |
| Organic Cornstarch | ½ | cup |
| Xanathan Gum | 3½ | teaspoons (t) |
| Guar Gum | 2½ | t |
| Salt | ¼ | t |
| Aluminum Free Baking Powder | ½ | t |
| Baking Soda | ¼ | t |

In yet another embodiment of the present invention, a dry scone mix is provided in accordance with the ingredients and approximate amounts listed in Table 8 below.

TABLE 8

| Ingredient | Approximate Amount | |
|---|---|---|
| Dry Base From Table 1 | 4 | cups |
| Earth Balance Vegan Buttery Spread | 4 | cups |
| Organic Pecan Meal and/or Flaxmeal | ½ | cup |
| Organic Evaporated Cane Juice | 1¾ | cups |
| Organic Maple Sugar | 1¾ | cups |

In yet another embodiment of the present invention, a dry base mix is provided in accordance with the ingredients and approximate amounts listed in Table 9 below.

TABLE 9

| Ingredient | Approximate Amount | |
|---|---|---|
| Dry Base From Table 1 | 4 | cups |
| Organic Stabilized Rice Bran | 1 | cup |
| Organic Flaxmeal | ½ | cup |
| Organic Sorghum Flour | ½ | cup |
| Organic Sucanot | ½ | cup |
| Organic Hemp Seeds | ⅛ | cup |
| Organic Palm Shortening | 3½ | t |
| Yeast | ⅓ | cup |
| Organic Buckwheat Groats | 1 | Tbs |
| Organic Agave Nectar | 1 | Tbs |
| Organic Evaporated Cane Juice | 1 | Tbs |
| Pure Noni Fruit (dried or liquid) | 1 | Tbs |
| Apple Cider Vinegar | 1 | Tbs |

In yet another embodiment of the present invention, a wet base mix is provided in accordance with the ingredients and approximate amounts listed in Table 10 below.

TABLE 10

| Ingredient | Approximate Amount | |
|---|---|---|
| Soy Milk | 8 | cups |
| Rice, Hemp and or Almond Milk | 4 | cups |
| Water | 4 | cups |
| Soy Lecithin | 3 | Tbs |
| Vanilla Extract | 3 | Tbs |
| Maple Extract | 3 | Tbs |
| Soy Lecithin | 2 | Tbs |
| Canola, Vegetable, Olive and/or Grape Seed Oil | 1 | cup |

In yet another embodiment of the present invention, another web base mix is provided in accordance with the ingredients and approximate amounts listed in Table 11 below.

TABLE 11

| | |
|---|---|
| Ingredient | Approximate Amount |

Wet Ingredients

| | | |
|---|---|---|
| Organic Vanilla Soy Milk | 8 | cups |
| Organic Vanilla Rice, Almond or Help Milk | 4 | cups |
| Organic Raw whole almonds | 1 | cup |
| Filtered Water | 4 | cups |
| Soy Lecithin | 3 | Tbs |
| Orlando Pure Organic Clear Mexican Vanilla | 3 | Tbs |
| Extract | | |
| Pure Organic Madagascar Bourbon Vanilla | 3 | Tbs |
| Extract | | |
| Pure Organic Mexican Vanilla Extract | 3 | Tbs |
| Expeller Pressed Canola, Vegetable and or | 1 | cup |
| Extra Virgin Olive Oil | | |

In at least one embodiment of the present invention, a disclosed gluten free vegan dry mixture is added to a disclosed wet mixture to form a composition/mixture ready for baking. Once the resulting composition/mixture is baked at the appropriate temperature for an appropriate amount of time, the resulting baked goods provide a better taste, texture and nutritional content when compared to other baked goods. It should be appreciated that all different flavors and varieties (e.g., chocolate, vanilla, and unsweetened) of milk and oil may be used with various embodiments of the present invention.

It should also be appreciated that it is within the scope of the present invention to modify the ingredients of the present invention as necessary and known to one or ordinary skill in the art. For example and not by limitation, known baking additives, including but not limited to, whole flaxseed, wax orchards fruit sweetener, maple extract, banana extract, maple sugar, pure cinnamon, pumpkin pie spice (cinnamon, ginger, allspice, ground cloves, nutmeg) dark cocoa, cocoa, banana flavoring (dry), pecans, blueberries, strawberries, white peaches, granny smith apples, pumpkin, bananas, dark chocolate chips, nut butters: cashew, almond, macadamia/cashew, peanut, raw coconut butter, coconut milk, dark chocolate chips peanut butter chips, raw sugar, margarine, chocolate chips, fruits, pecans, pecan meal, may be used or, where appropriate, substituted, in the disclosed embodiments.

It should also be appreciated that conditions for successful stabilization typically require relatively low humidity and chilled ingredients. Additionally, in at least one embodiment, when a mixture, composition, or recipe calls for yeast, fermenting it in buckwheat (or ground buckwheat groats) first will allow the yeast to grow, typically resulting in baked goods with additional or improved rise. It should also be appreciated that the gluten-free embodiments disclosed typically require a longer bake time than traditional baked goods. Sufficient cooling time is necessary for products to “firm” up in the center.

It should be appreciated that where any of the embodiments of the present invention require a starch, Expandex® (Corn Products International Inc., Westchester Ill.), which is a modified tapioca starch made from the tapioca root, or similar modified or unmodified starches can be used. It should also be appreciated, that for any ingredient described and claimed herein, its known equivalent, known now or in the future, can be used instead of the indicated ingredient. Additionally, it should also be appreciated that for each ingredient, organic or non-organic ingredients may be used as part of the present invention. It should also be appreciated that approximately means about ±10% of the indicated ingredient or recipe.

In one embodiment of the present invention the indicated amounts of Expandex® modified tapioca starch and the cornstarch are combined together and then xanathan gum and guar gum, sea salt, baking powder, and baking soda are mixed together with the cornstarch and Expandex®. The Expandex® mixture is then combined together with any non gluten-free vegan flour mixture combination of one or more of the following: bean flour, rice flour, rice bran, coconut flour, stabilized rice bran, sorghum flour, brown rice flour, potato flour, buckwheat flour, potato starch, quinoa flour, or any non-gluten containing flour, to form a base dry mix.

While the compositions, recipes, mixtures and related methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures, compositions, formulations and mixtures. The present disclosure includes any and all embodiments of the following claims.

1. A wet mix for gluten-free baked goods comprising:
a. approximately 62/100 part soy, hemp, potato and/or almond milk;
b. approximately 31/100 part rice milk or water;
c. approximately 33/500 part oil; and
d. approximately 1/100 soy lecithin.
